(19) United States
(12) Patent Application Publication
(10) Pub. No.: US 2011/0140875 A1
(43) Pub. Date: Jun. 16, 2011

(54) TIRE PRESSURE ADJUSTMENT BASED ON VEHICLE LOAD

(75) Inventors: TUAN ANH BE, LIVONIA, MI (US); ARICK EVAN RUSHING, YPSILANTI, MI (US); LEONID TIKH, BLOOMFIELD HILLS, MI (US)

(73) Assignee: FORD GLOBAL TECHNOLOGIES, LLC, DEARBORN, MI (US)

(21) Appl. No.: 12/636,761

(22) Filed: Dec. 13, 2009

(51) Int. Cl. B60C 23/02

(52) U.S. Cl. 340/442

(57) ABSTRACT

A device for monitoring and adjusting tire pressure of a vehicle having a monitoring module and a computing module operatively coupled to the monitoring module. The monitoring module is configured to sense a tire pressure. Further, the monitoring module is configured to compare the sensed pressure with the low pressure limit value associated with the tire, to identify a low pressure condition. The computing module includes an interface module, configured to alert a user once the low pressure condition is identified and accept a new load value, and a processing module. The processing module is configured to generate a new tire pressure value based on the new load value, recommend the new tire pressure value to the user, and modify the tire pressure to the new tire pressure value upon a determination that the user accepts the new tire pressure value.

### BACKGROUND

This application relates generally to the field of vehicle suspensions, and more particularly to monitoring and adjusting the tire pressure of a vehicle.

Transport vehicles, such as pick-up trucks and the like, experience extremely variable loads. At times, the vehicle may be operated without any load at all, while at other times the load may include cargo or passengers, in varying amount or number. Owing to the distribution of load dictated by vehicle design, the load carried by the rear axle tends to be greater than the load carried by the front axle. Thus, rear tires generally require higher pressures than the front tires for optimal operation with a load. This situation can become problematic when the vehicle is unloaded, however, as the high pressure at the rear tires can result in poor vehicle handling, driver discomfort, and similar problems.

Manufacturers typically provide placards, attached to the vehicle, depicting optimal vehicle tire pressure values under varying load conditions. The placards recommend a lower front tire pressure than the rear tire pressure under maximum load conditions. In addition, to pressure levels will be recommended for the rear tires, a lower pressure for comfort and handling under lighter load conditions, and a higher pressure to accommodate heavier loads. This system is generally referred to as a “dual placard” or “split placard” system.

Dual placard operation presumes that the driver will change the rear tire pressures to the proper placard recommendation depending on the load. A problem with that assumption is that vehicles using a dual-placard system commonly employ non-fluid springs, and such suspension systems are generally incapable of determining the load on the vehicle or communicating that information to the driver. Accordingly, the driver may not change the pressure in the vehicle tires in accordance with the load conditions on the vehicle. This situation can undesirably lead to the problems noted above. Consequently, there remains a need for an easy and convenient adjustment of vehicle tire pressure, based on vehicle load, to maintain pressure within recommended ranges.

### SUMMARY

This disclosure presents a device for monitoring and adjusting tire pressure of a vehicle based on the vehicle's load. The system disclosed here includes a monitoring module, and a computing module operatively coupled to the monitoring module. The monitoring module is configured to sense the tire pressure and compare the sensed tire pressure with a low pressure limit value to identify a low pressure condition. The computing module includes an interface module and a processing module. The interface module is configured to alert a user when a low pressure condition is identified, and accept a new load value from the user. Further, the processing module is configured to generate a new tire pressure value based on the new load value, recommend the new tire pressure value to the user, and modify the tire pressure to the new tire pressure value upon a determination that the user accepts the new tire pressure value.

### BRIEF DESCRIPTION OF THE DRAWINGS

The drawing figures described below set out and illustrate a number of exemplary embodiments of the disclosure. Throughout the drawings, like reference numerals refer to identical or functionally similar elements. The drawings are illustrative in nature and are not drawn to scale.

FIG. 1 is a top view of an embodiment of a device of the present disclosure employed in an exemplary vehicle suspension system of a vehicle.

FIG. 2 is a perspective view of a trailer illustrating an example of the present disclosure.

FIG. 3 is a flow chart illustrating an embodiment of a method of the disclosure.

FIG. 4 is a flow chart illustrating another embodiment of the method of FIG. 3.

### DETAILED DESCRIPTION

The following detailed description is made with reference to the figures. Exemplary embodiments are described to illustrate the subject matter of the disclosure, not to limit its scope, which is defined by the appended claims.

In general, the present disclosure describes a tire pressure adjustment device for adjusting the tire pressure of a vehicle based on the vehicle's load. The adjustment device described in this disclosure is generally applicable to any vehicle that carries a load, such as trucks of all sizes, vans, SUV's and trailers. The adjustment device is capable of monitoring the vehicle's tire pressure and indicating to the user when the tire pressure value drops below a pre-defined threshold value due to changes in vehicle load. The adjustment device is also capable of accepting a new load value from the user, selecting an appropriate new pressure value corresponding to the new load, and modifying the tire pressure values to the new pressure value. Accordingly, proper vehicle handling and optimal performance of the vehicle may be achieved.

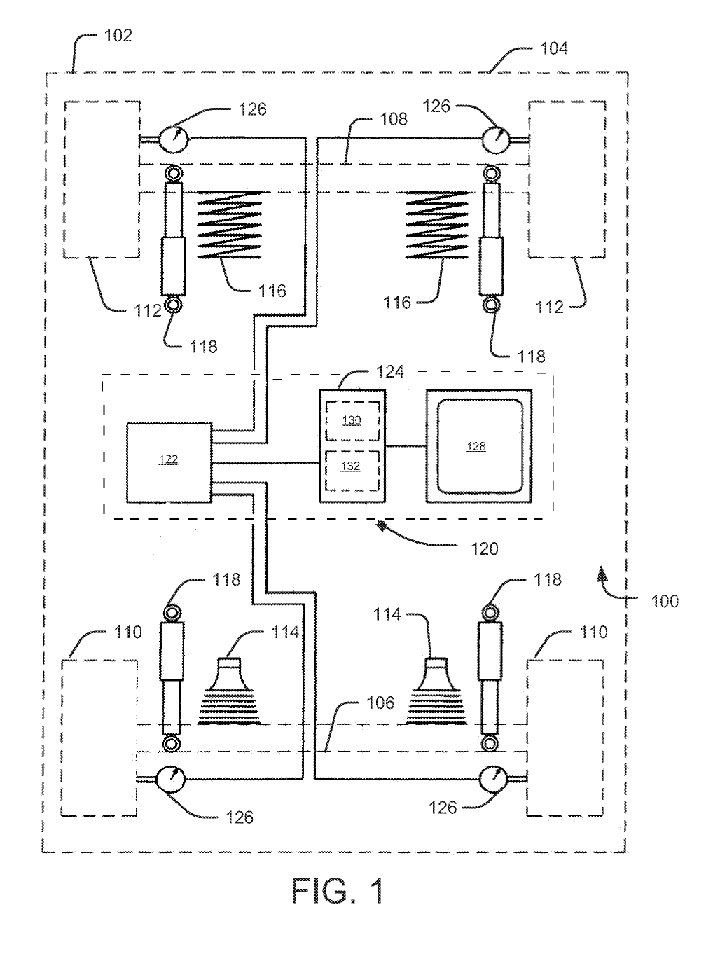

FIG. 1 illustrates a top view of an embodiment of a device of the present disclosure employed in an exemplary vehicle suspension system 100 of a vehicle 102. The vehicle 102 includes a vehicle body 104 supported on a rear axle 106 and a front axle 108, rear tires 110, and front tires 112. The vehicle suspension system 100 is connected between the vehicle body 104, and the rear axle 106, the front axle 108, the rear tires 110, and the front tires 112. Further, the vehicle suspension system 100 includes one or more first non-fluid springs 114, such as leaf springs disposed along the rear of the vehicle 102. The vehicle suspension system 100 may also include one or more second non-fluid springs 116, such as coil springs disposed along the front of the vehicle 102. It will be evident to those skilled in the art that even though FIG. 1 illustrates a particular type of the non-fluid springs 114 and 116, the vehicle suspension system 100 may include any other suitable configuration of non-fluid springs 114 and 116, such as torsion springs, or any suitable configuration of fluid springs. Furthermore, the vehicle suspension system 100 includes one or more shock absorbers 118 disposed along the front and rear of the vehicle 102 connected with the non-fluid springs 114 and 116 as known in the art.

In the present embodiment of the disclosure, a tire pressure adjustment device 120 (hereafter referred to as adjustment device 120) operates in the vehicle suspension system 100 of the vehicle 102. The adjustment device 120 is capable of monitoring and adjusting the tire pressure of the vehicle 102 based on vehicle load. Specifically, the adjustment device 120 monitors the tire pressure of the vehicle 102 and indicates to the user when the tire pressure drops below a pre-defined threshold value due to change in vehicle load. Thereafter, the adjustment device 120 may modify the tire pressure of the vehicle 102 to an appropriate value.

The adjustment device 120 includes a monitoring module 122 and a computing module 124. The monitoring module 122 is connected to the rear tires 110 and the front tires 112 through electrical or wireless connections. Further, the monitoring module 122 is configured to sense the tire pressure of the tires 110 and 112. Specifically, the monitoring module 122 may include at least one pressure sensor, such as pressure sensors 126 to sense the pressure of the tires 110 and 112. The pressure sensors 126 are operatively associated with the tires 110 and 112 of the vehicle 102 and the monitoring module 122 in any suitable manner known in the art. For example, the pressure sensors 126 may be in direct electrical communication with the monitoring module 122, through leads, conductors, and the like, or the pressure sensors 126 may communicate with the monitoring module 122 through wireless connection. A variety of suitable sensor components is available to those in the art for accomplishing these results. More specifically, the pressure sensors 126 produce an output representing the air pressure inside the tires 110 and 112. In one implementation, the output of the pressure sensors 126 is provided to the monitoring module 122 as digital values. Alternatively, the output of the pressure sensors 126 may be provided to the monitoring module 122 as analog values, and the monitoring module 122 may be configured to process the signals initially through an analog to digital conversion unit, or to employ analog signals directly.

Further, a low pressure limit value is associated with the tires 110 and 112. The low pressure limit value may be a predetermined threshold pressure value required for optimal performance and proper handling of the vehicle 102. The monitoring module 122 is configured to compare the sensed pressures of the rear tires 110 with the low pressure limit value to identify a low pressure condition. Specifically, the monitoring module 122 continuously receives pressure values from the pressure sensors 126. The received pressure values may then be examined periodically by the monitoring module 122 to determine whether the tire pressure is lower than the low pressure limit value. It will be evident to those skilled in the art that the monitoring module 122 may receive the pressure values from the pressure sensors 126 on a periodic basis.

The monitoring module 122 provides the monitored tire pressure value to the computing module 124, where, the computing module 124 is associated with the monitoring module 122. The computing module 124 may also include an interface module 128, a processing module 130, and a memory 132. The computing module 124 may be a standalone computing device, or it may be a functional portion of the primary vehicle computing device (not shown). Computing devices are standard equipment on vehicles in current production, and the computing device designed for the vehicle in question will be easily programmable to accommodate the requirements of the present disclosure. The interface module 128 is shown at a particular position in FIG. 1 for clarity, but, it will be understood that the interface module 128 will be placed in the vehicle compartment at a position easily accessible and viewable by the user. The details of the user interface can be left to those in the art, using devices such as touch screens, buttons, or the like. Aural interfaces, employing speech recognition technology, are also available in the art.

Specifically, the interface module 128 of the computing module 124 receives input from the monitoring module 122 to alert a user once a low pressure condition is identified. In the present embodiment, a low pressure condition is identified when the tire pressure is lower than the low pressure limit value. This condition typically occurs when the load on the rear tires 110 decreases, due to a decrease in the number of the passengers or the amount of cargo, for example. On receiving a low pressure condition as input from the monitoring module 122, the interface module 128 generates an alert, such as a visual and/or audible signal or other suitable indication for the low pressure condition.

The interface module 128 can also receive a new load value as an input from the user. Users are aware, of course, when major changes in vehicle load occur, and a user may well decide to input new load values at such times. In an exemplary embodiment of the disclosure, on a determination that the user decides to modify the tire pressure of the rear tires 110, the interface module 128 may receive the new load value. It will be evident to those skilled in the art that the interface module 128 may receive the new load value by any means known in the art, such as via a touch screen, a keyboard, voice commands, and the like, as noted above. After receiving the new load value, the interface module 128 may output the new load value to the processing module 130 through direct electrical connections or a wireless connection. As wall so be clear to those in the art, a decision to modify tire pressure can be taken by automated devices, such as any of the elements of computing module 124, or similar devices known now or in the future.

On receiving the new load value from the interface module 128, the processing module 130 generates a new tire pressure value based on the new load value. Specifically, the new tire pressure value is generated based on the new load value using a vehicle-specific look-up table located in the memory 132, where, direct associated tire pressure values corresponding to a various load values are stored. In the look-up table, the processing module 130 maps the new load value with a direct associated new pressure value, and communicates the new pressure value to the interface module 128 through a hardwired or wireless connection. Specific tire pressure values will vary with individual vehicles, as known in the art.

Thereafter, the interface module 128 outputs the new tire pressure value to the user via a visual or audible signal. Along with the new tire pressure value, the interface module 128 also outputs a message to the user stating that an acceptance to modify the pressure of the rear tires 110 is required. On determination that the user accepts the new tire pressure value, the processing module 130 then modifies the tire pressure of the rear tires 110 to the new tire pressure value. In a fully automated system, acceptance may be similarly automated, and the device making the decision will generate an exceptions signal, as is known in the art.

The change in the pressure of the rear tires 110 requires a change in the low pressure limit value. Such an operation may be performed by the processing module 130 by calculating a new low pressure limit value for the rear tires 110 based on the on the new tire pressure value, using the look-up table stored in the memory 132, or any other look-up table. Specifically, the processing module 130 maps the new pressure value with an associated new low pressure limit value in the look-up table. Alternatively, the processing module 130 may map the new load value with an associated new low pressure limit value in the look-up table. The monitoring module 122 utilizes the new low pressure limit value for comparison with the new tire pressure value.

It should be clear to those in the art that the computing module 124 may be limited to the functions described above, or an enhanced version could perform a number of functions related either generally to vehicle operation, or specifically to the suspension and tire systems. For example, the lookup table could contain data relating to the various tires suitable for mounting on the vehicle. Then, the user simply could indicate the tires models installed, and the computing module could more precisely calculate required values. Additionally, the computing module 124 could accept information on when each tire was installed. Then, based on information obtained from the odometer or other record-keeping system, the module could alert the user at various wear intervals for activities such as inspections or tire rotation.

As will be appreciated by those in the art, the actual adjustment of tire pressures can be accomplished manually or automatically. If a manual option is desired, then the user adjusts tire pressures in an entirely conventional manner. An automatic system would operate similarly, employing inflation and control means (not shown) as known in the art.

It will also be evident to those skilled in the art that though FIG. 1 illustrates the adjustment device 120 for monitoring and adjusting tire pressures of the rear tires 110, the adjustment device 120 may be used to monitor and adjust the tire pressures of the front tires 112, or a combination of the rear tires 110 and the front tire 112. Further, the adjustment device 120 may be used to monitor and adjust the tire pressure of one of the rear tires 110, or one of the front tires 112, or any combination thereof, without departing from the scope of the present disclosure.

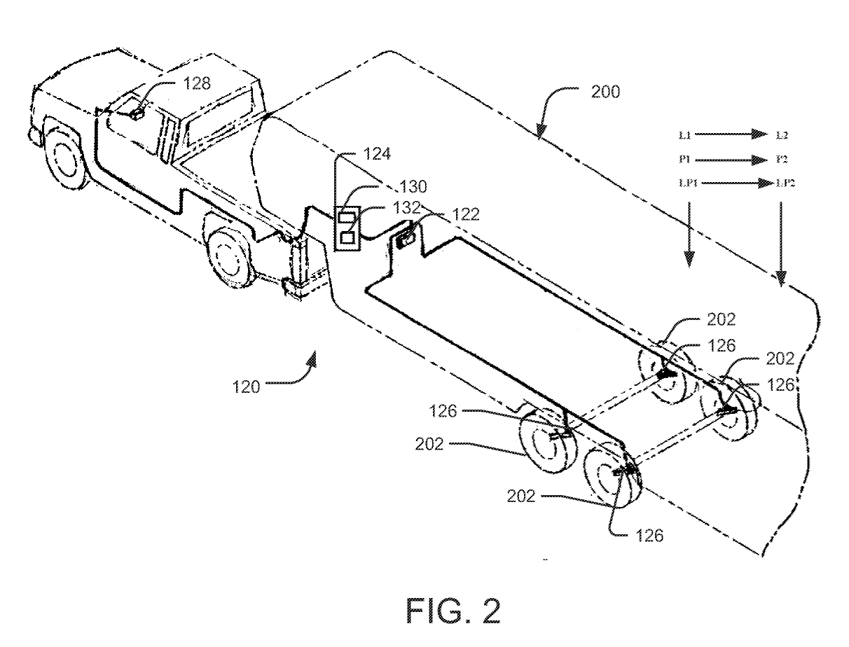

FIG. 2 depicts a perspective view of a trailer 200 having rear tires 202, employing the adjustment device 120, to illustrate an example of the present disclosure. The trailer 200 may operate in a loaded condition and an unloaded condition. In the loaded condition, the initial load on the trailer may be L1 and the initial pressure of the rear tires 202 of the trailer 200 may be P1. Further, a low pressure limit value LP1 may be associated with the rear tires 202 of the trailer 200. The low pressure limit value LP1 is the threshold pressure value of the rear tires 202 required for optimal performance of the trailer 200.

Furthermore, the pressure sensors 126 receive pressurized air as input from the rear tires 202 of the trailer 200. The pressure sensors 126 output the pressure values to the monitoring module 122. Specifically, the pressure sensors 126 continuously measure the pressure P1 and communicate the sensed pressure to the monitoring module 122.

The monitoring module 122 continuously compares the sensed pressure value received from the pressure sensors 126 with the low pressure value LP1. When some cargo from the trailer 200 is unloaded, the pressure P1 may drop below the low pressure limit value LP1. This drop in pressure value is sensed by the monitoring module 122 and communicated to the interface module 128 of the computing module 124. The interface module 128 may then output a message on an output device such as a touch screen, a speaker, or a display, to alert the user that the pressure value has dropped below LP1. The monitoring module 128 will also detect pressure changes caused by environmental conditions, as might occur when a vehicle stands in bright sunlight, experiences a change in altitude or operates for a prolonged period. The system will compensate for such conditions as well.

Thereafter, the user may input a load value L2 corresponding to the current load on the trailer in the interface module 128. The interface module 128 then communicates the new load value L2 to the processing module 130, which may search the new load value L2 in a look up table T1 stored in the memory 132. The look-up table may include a direct associated pressure value P2 to the load value L2. The processing module 130 maps the load value L2 with the pressure value P2, and communicates P2 to the interface module 128. The interface module 128 then displays P2 to the user on the touch screen along with a message stating that an acceptance to modify the pressure of the rear tires 110 to the new pressure value P2 is required.

The user may accept the new pressure value P2 by selecting a yes option on the touch screen. It will be evident to those skilled in the art that any other form of option may be available to the user to indicate acceptance of the new pressure value P2. This user input is received by the interface module 128 and communicated to the processing module 130. The pressure of the rear tires 202 of the trailer 200 is then modified to P2. Further, the processing module 130 may search the new pressure value P2 in a look up table T2 stored in the memory 132 and map P2 with an associated low pressure value LP2, corresponding to the rear tires 202 of the trailer 200. The processing module 130 modifies the low pressure value from LP1 to LP2 and communicates the same to the monitoring module 122. It will be evident to those skilled in the art the illustrative example of the trailer 200 discussed above applies equally to all sorts of vehicles, such as trucks or SUVs.

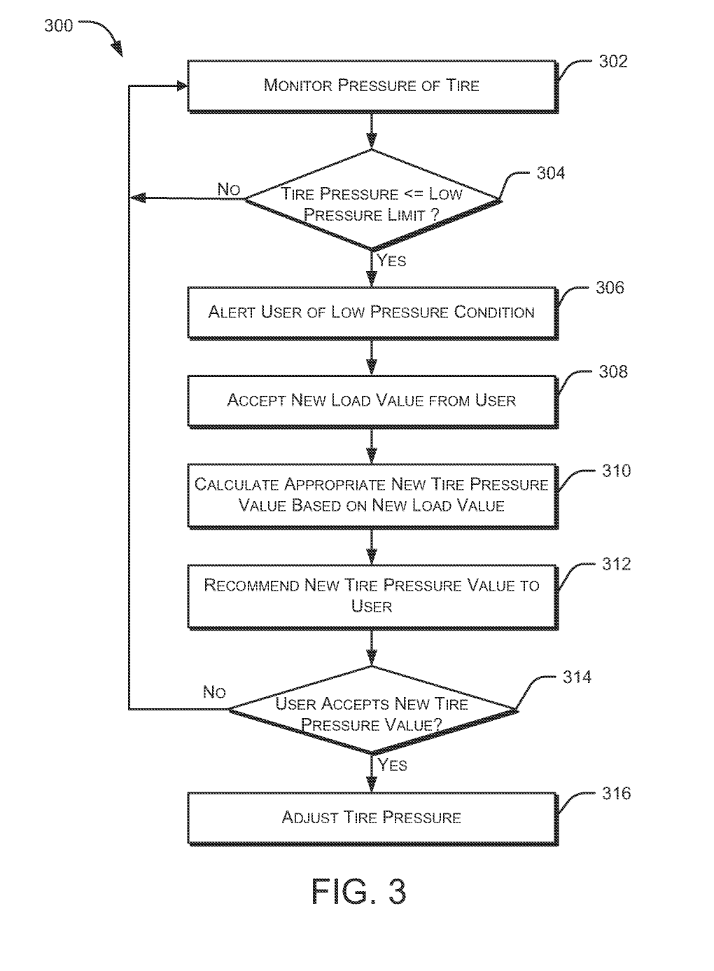

FIG. 3 illustrates a method 300 for carrying out the subject matter of the disclosure. The method 300 starts at step 302, where, the monitoring module 122 monitors the tire pressures of the rear tires 110 of the vehicle 102. Further, as described in conjunction with FIG. 1, a low pressure limit value is associated with the rear tires 110. At step 304, the monitoring module 122 compares the monitored tire pressure with the low pressure limit value to identify a possible low pressure condition, where, the tire pressure of the rear tires 110 is less than the low pressure limit value. Subsequently, on determination of a low pressure condition, the interface module 128 outputs a signal at step 306 to alert the user regarding the low pressure condition. Thereafter, the interface module 128 may accept a new load value from the user, at step 308. In addition, the monitoring module 122 continues to monitor the tire pressure for occurrence of the low pressure condition.

At step 310, the processing module 130 calculates a new tire pressure value for the rear tires 110 based on the new load value. The new tire pressure value may be calculated using the look-up table stored in the memory 132, where, direct associated tire pressure values corresponding to a plurality of load values are stored. In the look-up table, the processing module 130 maps the new load value with a direct associated new pressure value. At step 312, the processing module 130 may recommend the new tire pressure value to the user.

Upon determination that the user accepts the new tire pressure value at step 314, the tire pressure of the rear tires 110 may be adjusted to the new tire pressure value, at step 316. If the user rejects the new tire pressure value, the method 300 returns to step 302. At step 302, the monitoring module 122 continues to monitor the tire pressure of the rear tires 110. In addition, the processing module 130 may calculate a new low pressure limit value for the rear tires 110 based on the on the new tire pressure value, upon modification of the tire pressure to the new tire pressure value. The new low pressure limit value may be calculated using the look-up table stored in the memory 132, or any other look-up table. The monitoring module 122 utilizes the new low pressure limit value for comparison with the new tire pressure value.

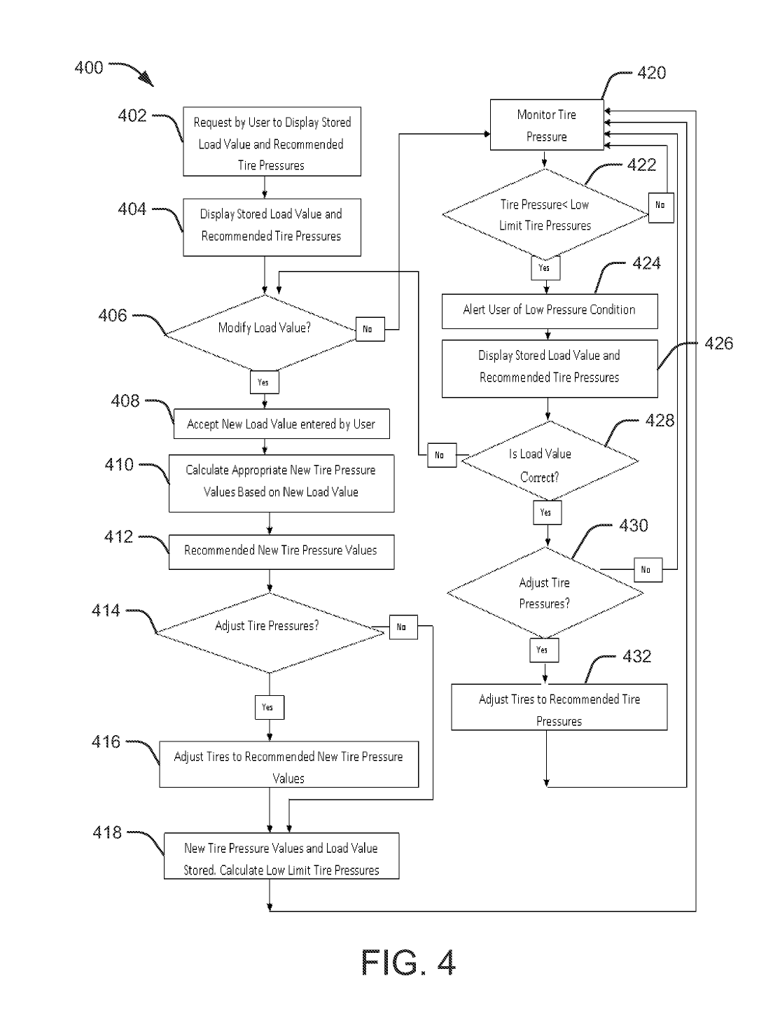

FIG. 4 illustrates an alternate embodiment of the method 300 of the disclosure. Method 400 starts at step 402, where, the interface module 128 receives a request from the user to display stored load value and recommended tires pressures. The user may input the request using a touch screen, a voice command, an input device such as a keypad, or the like. The interface module 128 communicates the request to the memory 132, where, the load value and the recommended tire pressures are stored. The memory 132 outputs the load value and the recommended tire pressures to the interface module 128. The interface module 128, then displays the stored load value and the recommended tire pressures to the user, at step 404.

Further, at step 406, the method 400 determines if the user wants to modify the load value. On determination that the user wants to modify the load value, the interface module 128 accepts a new load value as an input from the user, at step 408. Subsequently, at step 410, the processing module 130 calculates an appropriate new tire pressure value for the rear tires 110 based on the new load value. The step 410 is similar to step 310 of the method 300, and accordingly, a description thereof is avoided herein for the sake of brevity. Subsequently, at step 412, the processing module 130 recommends the new pressure value for the rear tires 110 to the user.

Upon determination that the user accepts the new pressure value at step 414, the processing module 130 modifies the tire pressure of the rear tires 110 to the new tire pressure value, at step 416. Further, at step 418, the processing module 130 stores the new tire pressure value and the new load value in the memory 132, and calculates a new low pressure limit value for the rear tires 110. The new low pressure limit value is calculated based on the new tire pressure value using the look-up table stored in the memory 132. Furthermore, if the user rejects the new tire pressure value at step 414, the method 400 moves to step 418.

At step 420, the monitoring module 122 monitors the tire pressure of the rear tires 110 of the vehicle 102. Thereafter, at step 422, the monitoring module 122 compares the tire pressure with the low pressure limit value to identify the low pressure condition, where, the tire pressure of the rear tires 110 is less than the low pressure limit value. Subsequently, on determination of the low pressure condition, the interface module 128, at step 424, generates output signals to alert the user regarding the low pressure condition. In addition, the monitoring module 122 continues monitoring the tire pressures for the occurrence of low pressure condition.

After alerting the user regarding the low pressure condition, the interface module 128 displays the stored load value and recommended tire pressures, at step 426. Thereafter, at step 428, the method 400 determines if the load value is correct. If the load value is incorrect, the method 400 returns to step 406. If the load value is correct, at step 430 the processing module 130 determines if the user wants to adjust the tire pressures of the rear tires 110 of the vehicle 102. The interface module 128 may display a message requiring a confirmation from the user that the tire pressure needs to be adjusted.

Upon determination that the user wants to adjust the tire pressures at step 430, the processing module 130 adjusts the tire pressures of the rear tires 110 to the recommended tire pressures at step 432. Thereafter, the method 400 returns to step 420, where the monitoring module 122 monitors the tire pressure. Also, if the user rejects the tire pressure adjustment at step 430 or rejects the modification in the load value at step 406, the method 400 returns to step 420.

It will also be evident to those skilled in the art that though FIGS. 3 and 4 illustrate the methods 300 and 400 for monitoring and adjusting tire pressure of the rear tires 110, however, the methods 300 and 400 may be used to monitor and adjust the tire pressure of the front tires 112, or a combination of the rear tires 110 and the front tires 112. Further, the methods 300 and 400 may be used to monitor and adjust the tire pressures of one of the rear tires 110, or one of the front tires 112, or any combination thereof, without departing from the scope of the present disclosure.

Those in the art will understand that the steps set out in the discussion above may be combined or altered in specific adaptations of the disclosure. The illustrated steps are set out to explain the embodiment shown, and it should be anticipated that ongoing technological development will change the manner in which particular functions are performed. These depictions do not limit the scope of the disclosure, which is determined solely by reference to the appended claims. In addition, the fact that the embodiments of FIGS. 2-4 disclose manual systems does not preclude the incorporation of automated control means, as discussed in connection with FIG. 1. Such automated control devices specifically fall within the ambit of the claims appended hereto.

The present disclosure provides a device, such as the adjustment device 120, and methods, such as methods 300 and 400, for monitoring and adjusting the tire pressures of the vehicle embodying the following advantages. The device and the methods enable an easy and convenient adjustment of vehicle tire pressures as the vehicle load changes, to maintain pressures within recommended ranges. Accordingly, the vehicle operates at proper pressures of the tires. The proper tire pressures enable proper handling of the vehicle. Further, over-all vehicle operation is optimized to suit the load condition of the vehicle.

The specification has set out a number of specific exemplary embodiments, but those skilled in the art will understand that variations in these embodiments will naturally occur in the course of embodying the subject matter of the disclosure in specific implementations and environments. For example, some other database may be used instead of the look-up table. It will further be understood that such variation and others as well, fall within the scope of the disclosure. Neither those possible variations nor the specific examples set above are set out to limit the scope of the disclosure. Rather, the scope of claimed invention is defined solely by the claims set out below.

What is claimed is:

1. A device for monitoring the tire pressure of a vehicle, based on the vehicle's load, the device comprising:
a monitoring module configured to:
sense a tire pressure; and
compare the sensed tire pressure with a low pressure limit value to identify a low pressure condition; and
a computing module operatively coupled to the monitoring module, including:
an interface module configured to:
alert upon identifying the low pressure condition; and
accept a new load value; and
a processing module operatively coupled to the interface module, configured to:
generate a new tire pressure value based on the new load value;
recommend the new tire pressure value; and
modify the pressure of the tire to the new tire pressure values upon acceptance of the new tire pressure value.

2. The device of claim 1, wherein the monitoring module comprises at least one pressure sensor to sense the pressure of the tire.

3. The device of claim 1, wherein the low pressure condition is identified when the pressure of the tire is lower than the low pressure limit value.

4. The device of claim 1, wherein the interface module is configured to accept the new load value upon a determination that pressure of the tire should be modified.

5. The device of claim 1, wherein the processing module provides the new tire pressure value to the interface module for acceptance.

6. The device of claim 1, wherein the interface module displays the new tire pressure value corresponding to the new load value.

7. The device of claim 1, wherein the processing module calculates a new low pressure limit value for the tire based on the new tire pressure value, upon modification of the tire pressure to the new tire pressure value.

8. The device of claim 1, wherein the tire is a rear tire of the vehicle.

9. The device of claim 1, wherein the tire is a front tire of the vehicle.

10. A method for monitoring the tire pressure of a tire for a vehicle, based on the vehicle's load, the method comprising:
monitoring pressure of the tire;
comparing the monitored pressure with a low pressure limit value to identify a low pressure condition;
alerting upon identifying the low pressure condition;
accepting a new load value and calculating an appropriate new tire pressure value based on the new load value;
recommending the new tire pressure value; and
modifying the pressure of the tire to the new tire pressure value upon acceptance of the new tire pressure valuer.

11. The method of claim 10, wherein the modifying step further includes calculating a new low pressure limit value for the tire based on the new tire pressure value, upon modification of the tire pressure to the new tire pressure value.

12. The method of claim 11, wherein the new low pressure limit value is compared with the new tire pressure value.

13. The method of claim 10 further comprising monitoring the pressure of the tire upon a determination that the new tire pressure value is rejected.

14. The method of claim 10, wherein the low pressure condition occurs when the tire pressure is less than the low pressure limit value.

15. The method of claim 10, wherein the accepting step occurs upon a determination that the tire pressure should be modified.

16. A device for monitoring and adjusting tire pressure of a vehicle comprising:
a monitoring module configured to:
sense a tire pressure; and
compare the tire pressure with a low pressure limit value to identify a low pressure condition;
a computing module operatively coupled to the monitoring module, wherein the computing module includes:
an interface module configured to:
alert once the low pressure condition is identified;
accept a new load value upon a determination that the ire pressure should be modified;
display a new tire pressure value corresponding to the new load value selected; and
allow acceptance or rejection of the new tire pressure value; and
a processor configured to:
generate the new tire pressure value based on the new load value; and
modify the tire pressure to the new tire pressure value upon acceptance of the new tire pressure value.
